(19) United States
(12) Patent Application Publication
(10) Pub. No.: US 2024/0351072 A1
(43) Pub. Date: Oct. 24, 2024

(54) A SCREEN ATTACHMENT FOR A SCREENING MACHINE

(71) Applicant: Hewitt Robins International Ltd, Swadlincote (GB)

(72) Inventor: Zedenk Kresan, Swadlincote (GB)

(21) Appl. No.: 18/682,808

(22) PCT Filed: Aug. 8, 2022
(86) PCT No.: PCT/GB2022/052063

§ 371 Date: Feb. 9, 2024

(30) Foreign Application Priority Data
Aug. 9, 2021 (GB) 2111453.3

(51) Int. Cl. B07B 1/49

(52) U.S. Cl. CPC B07B 1/49

(57) ABSTRACT

A deck (10) for a screening machine comprising: a plurality of screen mats (14a, 14b, . . . 14n) arranged to define a screen channel (12) for screening a material; a support framework comprising a plurality of transverse members (18a, 18b), each transverse member (18a, 18b) comprising an edge retention channel (22) within which an edge portion (24, 26) of at least one screen mat is received; a rigid retention member (28) which is received within the edge retention channel (22) so as to clamp the edge portion (24, 26) in place, wherein the retention member (28) is attached to the transverse member (18a. 18b) by at least one attachment.

### TECHNICAL FIELD OF THE INVENTION

The present disclosure relates to a screen attachment for attaching a screen mat to a screening machine.

### BACKGROUND TO THE INVENTION

Flip-flow screening machines, which may also be referred to as flip-flop screens or elastic mesh screens, are well known in the art and used in several industries to separate different materials such as aggregates, minerals, recyclable materials, construction materials and biomass.

A flip-flow screening machine comprises a vibrating deck having screen mats with appropriately sized apertures to allow material to fall through and sieved out when the deck is vibrated.

A deck of a flip-flow screening machine typically comprises a plurality of screen mats which are arranged in a side-by-side relation transverse to the length of the deck and attached to respective transversely extending beams. The industry standard method of attaching the screen mats to the transverse beams is by use of a wedge strip which is impact fitted (i.e. hammered) in between opposing edges of adjacent mats which are received within a cavity of a transverse beam. An example of the hammered wedge strip is provided in, for example, CH627379.

Despite being an industry standard approach to fixing screen mats to a deck, the fitting process is time consuming and relatively labour intensive. Further, the removal of the hammered wedge strips is difficult when screens need to be replaced for repair or maintenance purposes.

The present invention seeks to provide an improved way of attaching a screen mat to the supporting structure of a screening machine.

### SUMMARY OF THE INVENTION

The present invention provides a deck for a screening machine comprising: a plurality of screen mats arranged to define a screen channel for screening a material; a support framework comprising a plurality of transverse members, each transverse member comprising an edge retention channel within which an edge portion of at least one screen mat is received; a rigid retention member which is received within the edge retention channel so as to clamp the edge portion in place, wherein the retention member is attached to the transverse member by at a plurality of discrete attachments.

Providing a rigid retention member allows the screen mats to be clamped to the deck and subsequently removed more readily and with a minimal amount of labour. In some embodiments, the retention member may be non-rigid but affixed to the transverse member using a plurality of discrete attachment points. The rigidity of the retention member may be sufficient to prevent significant bending of the retention member when self-supported and/or to impart a distributed clamping force imparted by the discrete attachments.

The attachment may comprise a threaded attachment. The threaded attachment may comprise a nut and bolt. The nut may be attached to an underside of the transverse member. The nut may be a captive nut. The bolt head may be fully received within the retention member so as to be flush with or below a principal plane of the screen channel.

The retention member may be separated from a side wall of the edge retention channel so as to define a retention cavity in which the edge portion is clamped. The retention cavity may comprise a constriction at an upper end thereof. The side walls of the edge retention channel may be rigid so as to resist deformation by the retention member and screen mat during clamping of the screen mat.

The retention member may be elongate with a longitudinal axis which extends along the length of the transverse member. The retention member may be tapered in cross section so as to narrow from an upper portion towards a base of the edge retention channel. The angle of the taper may be between 11 and 13 degrees, preferably 12 degrees.

The retention member may comprise a lip at an upper edge thereof. The lip may provide a clamping surface which urges vertically downwards against a corresponding surface of the edge portion. The lip may comprise an surface which is inclined to the vertical. The inclination of the lip away from vertical may be greater than the angle of the tapered portion. The lip may comprise a horizontal surface.

The transverse member may comprise a box section on which the edge retention channel is formed. A base of the edge retention channel may be provided by an upper wall of the box section. The box section may comprise a sleeve through which the attachment passes. The sleeve may be a bolt sleeve. The sleeve may extend between upper and lower walls of the box section and act to prevent the box section compressing or becoming otherwise deformed during tightening of the attachment.

The edge retention channel may comprise a base and a pair of opposing sidewalls. The sidewalls may extend vertically and parallel to one another. Each of the opposing sidewalls may comprise an inner surface which faces the retention member and an upper surface. The edge portion may be configured to abut the inner surface and the upper surface.

The deck may further comprise a plurality of retention members corresponding to a single transverse member. The plurality of retention members may comprise a central retention member and an end retention member.

The end retention member may comprise a curved elongate member. The retention member may comprise a composite structure having a central member and an outer covering.

The central member may comprise a metal bar. The metal may be mild steel. The outer cover may comprise any suitably wear resistant or resilient material known in the art. In the one embodiment, the material of the outer cover may be the same as the screen mat. The material may comprise polyurethane.

The edge portion may be clamped in a non-deformed state. The non-deformed state may relate to the shape of the edge portion being unchanged before and after being clamped. The edge portion may not be bent, twisted or otherwise contorted during the clamping process.

Also disclosed herein is a screen mat for use in a deck according to the present disclosure. The screen mat may comprise a main panel comprising a plurality of apertures for screening a material and an edge portion extending along an edge of the main panel. The edge portion may comprise a retention flange which is received within the edge retention channel. The retention flange may comprise a neck portion at an upper end thereof. The neck portion may correspond to a restriction provided in the retention cavity of the transverse member and prevent the edge portion being withdrawn from the retention cavity once the retention member is clamped in place. The retention flange may extend perpendicularly downwards from the main panel with an internal angle of 90 degrees. The surface of the retention flange which abuts the retention member may be inclined to the vertical so as to match the opposing abutting surface of the retention member.

The retention flange may be flared so as to be wider at the bottom portion when compared to the upper portion.

Also disclosed herein is a method of attaching a screen mat to a screening machine or deck thereof. The method may comprise: inserting edge portions of adjacent screen mats within an edge receiving channel; inserting a retention member between the respective edge portions; attaching the rigid retention member to the edge receiving channel using plurality of discrete attachments. The method may further comprise attaching a central rigid retention member prior to attaching one or more end retention members.

The skilled person will appreciate that except where mutually exclusive, a feature described in relation to any one of the aspects, embodiments or examples described herein may be applied mutatis mutandis to any other aspect, embodiment or example. Furthermore, except where mutually exclusive, any feature described herein may be applied to any aspect and/or combined with any other feature described herein.

### BRIEF DESCRIPTION OF THE DRAWINGS

In order that the invention may be more clearly understood one or more embodiments thereof will now be described, by way of example only, with reference to the accompanying drawings, of which:

FIG. 1 shows a deck of a screening machine;

FIG. 2 shows a longitudinal section of the deck of FIG. 1;

FIG. 3 shows the section of FIG. 2 with two screen mas removed; and

FIG. 4 show a view of a retention member prior to being attached to the transverse member.

### DETAILED DESCRIPTION OF THE INVENTION

In the following detailed description, numerous specific details are set forth in order to provide a thorough understanding of various embodiments and the inventive concept. However, those skilled in the art will understand that the present invention may be practiced without these specific details or with known equivalents of these specific details, that the present invention is not limited to the described embodiments, and that the present invention may be practiced in a variety of alternate embodiments. It will also be appreciated that well known methods, procedures, components, and systems may have not been described in detail.

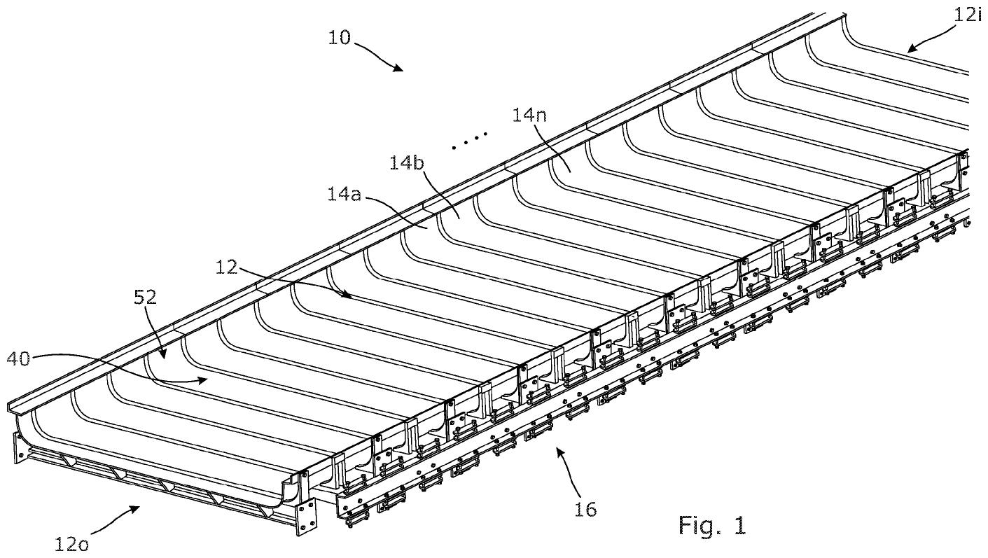

FIG. 1 discloses a screen deck 10 for an industrial screening machine, specifically a flip-flow screener. The screen deck 10 comprises framework of mechanical members which collectively provide a support structure 16 for a screening channel 12. The screening channel 12 comprises a plurality of screen mats 14a, 14b, . . . 14n. which are attached to the support structure 16 and include a matrix of suitably sized apertures (not shown) allowing a required separation of the screened material. The number and size of the screen mats 14a-n will vary upon application, but the screen mats 14a-n will typically be similar to each other. In the embodiment shown there are twenty-two individual screen mats 14a-n but this is not a limitation and the described embodiment may comprise a smaller or greater number of mats in other embodiments. For the purpose of the present disclosure, the attachment of a pair of adjacent screen mats 14a, 14b is described but it will be appreciated that the other mats within a screen channel 12 may be attached in a similar manner.

The size and distribution of the apertures within the screen mats 14a-c are not important for understanding the inventive concepts so not described further.

Materials to be screened are introduced to the channel 12 at a feed end 12i and passed along the length channel by action of the vibrating motion. This results in material smaller than the screen apertures passing through the apertures, and material which is larger than the apertures being moved along and collected at the outfeed 120. As noted in the background section, this type of machine and process is well-known in the art and so the vibration mechanism and other aspects of the screening machine are not described in detail here.

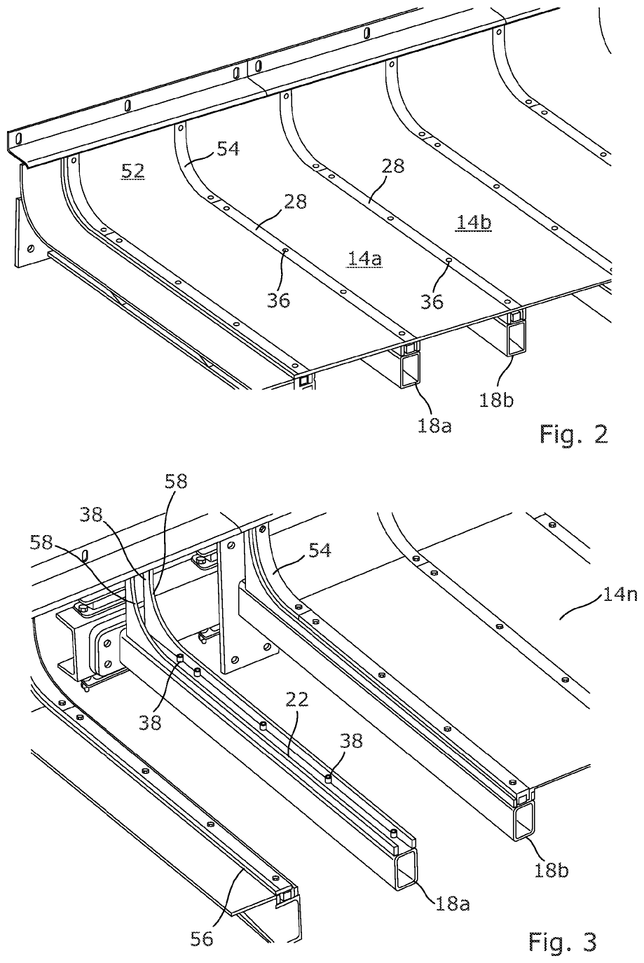

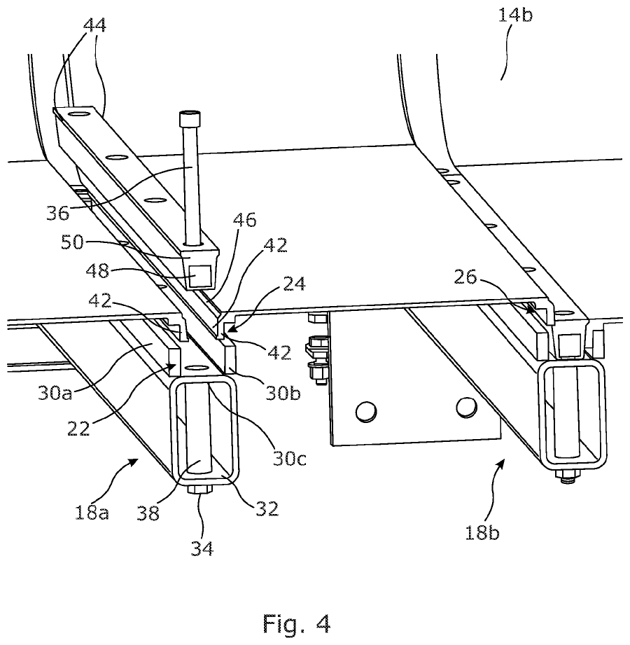

With reference to FIGS. 1 to 4, the present disclosure relates to the attachment of the screen members 14a-14c to the supporting framework.

The screening channel 12 is generally elongate and extends along a principal longitudinal axis. For the purpose of the description, the length L, width W and height H of the screening channel 12 are defined by the corresponding axes shown in FIG. 1.

The screen channel 12 comprises a series of abutting elongate screen mats 14a-c which extend lengthwise across the width of the screening channel 12. The ends of the screen mats 14a-c are upturned to define a sidewall of the screen channel 12, however, the sidewall being provided by the screen mats 14a-14c is optional in some embodiments and the sidewall may be defined by a separate member of the support structure or the like.

The screen mats 14a-c are arranged in a side-by-side relation along the length of the screen channel 12 in which the corresponding edges of adjacent screen mats 14a,b are received in and attached to a common support member (as described in detail below).

The supporting structure 16 may comprise any arrangement of structural members which are sufficient to provide the necessary structural support and vibrational driving action to the screen mats 14a-c. In the embodiment shown, the supporting structure 16 comprises a plurality of transverse members 18a,b which extend across screen channel 12 on the underside of the edges of the screen mats 14a,b. The ends of the transverse members are affixed to longitudinal side members 20 which extend along the length of the screen channel 12. As such, the longitudinal side members 20 and plurality of transverse members 18a,b form a ladder-like structure. As with the screen mats 14a,b, it will be appreciated that the plurality of transverse members 18a,b may be the same and so only one 18a is described in detail.

The spacing of the transverse members 18a,b corresponds to the width of the individual screen members 14a,b such that each transverse member 18,b supports at least one edge of an individual screen mat 14a,b.

The transverse members 18a,b generally comprise a channel 22 configured to receive the corresponding respective edges of the screen mats 14a, 14b along the length thereof. The edge receiving channels 22 are elongate having a length which extends across the width of the screening channel 12. The width of the edge receiving channel 22 is sufficient to receive the corresponding respective edge portions 24, 26 of the screen mats 14a, 14b and a rigid retention member 28 which is received between the respective edges 24, 26 of the screen mats 24, 26 to clamp them in place. The edge portions 24, 26 may be configured to be clamped by the retention member 28 in a non-deformed state such that they are not bent or significantly misshapen. It will be appreciated that, despite being in a non-deformed shape, there may be a degree of compression as dependent on the material the edge portion 24, 26 is made from, but the shape of the edge portions will be broadly unchanged.

The edge receiving channel 22 comprises opposing side walls 30a,b and a base 30c extending therebetween to define an open topped elongate cavity. The side walls 30a,b are configured to receive and retain the edges 24, 26 of the screen mats 14a,b so as to prevent lateral movement when the retention member 28 is inserted. The side walls 30a,b may extend vertically downwards in a plane which is normal to the plane of the screen mat 14a,b. The base 30c may be configured to receive one or more fixings of the rigid member. The shape of the edge receiving channel 22 may be any desired to correspond to the edges 24, 26, and rigid retention member 28.

The edge receiving channel 22 may be part of or be attached to a main body 32 of the transverse member 18a,b. The main body 32 may comprise any suitable structural member or members which have sufficient strength to traverse the width of the screen channel 22 whilst supporting the screen mat 14a,b and withstand the vibration. In the embodiment shown, the main body 32 comprises a hollow box section having a major axis aligned vertically. It will be appreciated that other structural members such as a C-beam, I-beam angle iron or other type of parallel flange channel may be used in place of a box beam.

In order to fix the rigid retention member 28 to the transverse member 18a,b, the arrangement may be provided with one or more suitable attachment devices. The attachment device may comprise, for example, a threaded connector such as a nut and bolt or stud. In the embodiment shown, the transverse member 18a,b is provided with a nut 34 which is configured to receive a bolt 36 which passes through the retention member 28 and channel base 30c. The nut 34 may be provided as a captive nut 34 which is affixed to either the main body 32 or the base 30c of the channel 22. In some embodiments the nut 34 may be provided by or within the retention member 28 with the bolt 36 being passed through the transverse member 18a,b. In other embodiments, the nut 34 may not be a captive nut. In other embodiments, the attachment may be provided by a stud and nut arrangement in which either the transverse member 18a,b or retention member 28 comprise a stud on which a nut may be received. It will be appreciated that other suitable attachment devices may be used.

In order to provide a distributed clamping force, the retention member 28 may be attached to the transverse member 18a,b at a plurality of locations along the length thereof. The number and distribution of the locations will vary depending on the application, however, the locations will typically me evenly distributed along the length of the retention member 28. In addition to providing a plurality of fixings, it will be appreciated that providing a rigid retention member 28 may assist with providing an even clamping force in which only a small number of fixings are required, thereby reducing the time required to affix the mats to the structural member 18a,b.

In the embodiment shown, the box section comprises a sleeve 38 into which the bolt 36 which passes through the retention member 28 is received. The bolt 36 may extend between the upper and lower walls of the box section of the main body 32 to provide additional compressive strength to prevent deformation of the box section when tightening the bolt 36 and during use.

The rigid retention member 28 comprises an elongate bar which is received, in use, between the adjacent screen mats 14a,b and is affixed to the transverse member 18a,b to prevent movement and/or separation of the screen mats 14a,b from the transverse members 18a,b. The retention member 28 may taper from top to bottom in the cross section such that the upper surface which provides the screen surface is wider than the lower end which is received within the channel 22. The taper provides the retention member with a generally wedge-shaped profile. The retention member may be symmetrical about a central vertical plane such that the taper angle is the same on each flank. The taper angle may be between 5 degrees and 7 degrees with respect to the vertical, preferably 6 degrees.

The separation between the opposition portions of the retention member 28 side surfaces and the channel sidewall 30a,b provides a cavity in which the edge portion 24, 26 of the screen mat 14a,b is located and captively retained by the retention member 28. Due to the taper of the retention member 28 and corresponding perpendicular orientation of the channel side wall 30a,b, the retention cavity is provided with a constriction towards the upper end which acts to entrap the screen mat edge portion 24, 26 within the cavity.

In the described embodiment, the screen mat 14a,b comprises a main panel 40 which terminates an edge 24, 26 which comprises an retention flange 42. The retention flange 42 is received and retained within the retention cavity defined between the retention member 28 and sidewall 30a,b of the channel 22. The retention flange 42 is sized and shaped to generally correspond to the retention cavity such that it is urged against channel side wall 30a,b by the retention member 28 when tightened down. In the described embodiment, the retention flange 42 extends downwards from the main panel 40 so as to extend into the channel 22 of the transverse member 18a,b. The retention flange 42 generally perpendicular to the plane of the main panel 40 and may comprise a solid member which is generally flared so as to expand from a neck, which comprises a narrow upper portion, to a wider base, thereby corresponding to the retention cavity. As such, the surface of the retention flange 42 which is adjacent the underside of the main panel 40 extends perpendicularly downwards from the main panel 40 with an internal angle of 90 degrees to correspond to the side wall 30a,b of the channel 22, and the tapered surface which abuts retention member 28 is angled with respect to the vertical at an angle which corresponds to the taper angle of the retention member 28.

An upper portion of the retention member 28 may comprise a vertical clamping surface which bears vertically downwards against a corresponding surface of the screen mat 14a,b when the retention member 28 is fixed in place. The clamping surface may be provided along an upper edge of the retention member 28 and be in the form of an elongate projection which extends outwardly and along the full length of the retention member 28. The projection may be a lip 44, a lateral external surface of which defines the widthwise extent of the retention member 28 at an upper surface thereof. The lip 44 may be sized to be received within a corresponding recess 46 provided in an upper edge of the screen mat edge 22, 24. The lip 44 may comprise a surface which is inclined to a greater degree to the vertical than the principal taper of the retention ember 28 so as to provide a greater downward clamping force on to the edge portion 24, 26. horizontally extending downwardly facing which abuts against a corresponding horizontal abutment surface of the edge portion 22,24, as provided by the recess 46. The lip 44 engages with the edge portion 22, 24 to provide additional stability to the joint.

The retention member 28 may be received between and cooperate with the adjacent edge portions 24, 26 of the screen mats 14a,b to provide a flush surface within the screen channel 12. The upper surface of the retention member 28 may be flush with the adjacent surfaces of the screen mats 14a,b to provide a continuous uninterrupted surface. As such, the thickness of the lip 44 may be the same as the depth of the recess 46.

The retention member 28 may be a composite structure comprising a central member 48 and an outer covering 50. The central member 48 may be configured to provide the retention member 28 with suitable rigidity and strength so as to avoid deformation when being clamped into place. The outer covering 50 may be made from a compliant material to aid the mating and surface contact of the retention member 28 between the opposing edge portions. The outer covering 50 may comprise a similar material to that of the screen mat 14a,b. The central member 48 may comprise a metal, such as mild steel.

The flank regions of the screen channel 12 may be provided with sidewalls 52 to retain the material within the channel 12 as it transitions along the length thereof. The sidewall 52 may comprise a vertically extending section and/or a radius which extends from the principal plane of the screen channel 12 and terminates at the upper extreme edge of the screen channel 12. As shown, the sidewall 52 may comprise an upturned end portion of the screen mats 14a,b to provide a continuous surface.

In order to accommodate the upturn, the edge retention channel 22 may also include a corresponding upturned portion at the longitudinal ends thereof.

In order to accommodate the upturns, the retention member 28 may comprise a plurality of sections. The plurality of sections may include one or more central member which clamps the principal plane of the screen mats 14a,b in place, and one or more end retention members 54 which clamp the upstanding walls of the screen channel 14a,b in place. The end retention member 54 may be rigid and may be longitudinally curved to match the curvature of the transverse member upstand.

The method of fixing the end retention members 54 to the upstands may be a bolted arrangement similar to that described above in connection with the principal plane of the screen mat 14a,b. In other embodiments, the end sections may be hooked on to a supporting member at an upper end thereof and bolted or otherwise affixed to the transverse member at the opposing end. In the embodiment shown, the upturned portions of the channel 22 are provided by flanges 58 which extend upwardly from the transverse member 18a,b. The fixing points are provided at either end of the curved retention member 54 such that a first bolt is affixed to the transverse member 18a,b and the second bolt is affixed to a back plate of the flanges 58.

The principal plane of the screen mat 14a,b may be substantially thinner stock than the edges 24,26.

The transverse member channel side wall may be configured to be received within a recess of the edge portion 24, 26 of the mat 14a,b. Thus, the edge portion 24, 26 comprises vertical and horizontal abutment surfaces.

The terminal end of the screen channel 12 may comprise an attachment having a dummy edge portion 56 which takes the place of a screen mat 14a,b. Hence, the retention member 28 and method of attaching the final mat may be the same as the intermediate mats.

In order to attach a screen mat 14a,b to the deck, the edge portions 24, 26 of adjacent screen mats are located within the edge receiving channel 18a,b prior to the retention member 28 being located between the respective edge portions 24, 26. The discrete attachments are then engaged with the transverse member 18a,b at the prescribed locations prior to being tightened. The wedge shape of the retention member 28 shown in the drawings proceeds to force the edge portions into the receiving channel until the upper surface of the side wall 30a, 30b contacts the underside of the screen mat and the attachments are fully engaged, e.g. screwed in and tightened. This process is reversed to move the screen mats 14a,b. The upstanding end portions 54 of the retention member 28 may be affixed after the central portion so that the central portion of the screen mat 14a,b is firmly located prior to anchoring the ends.

The one or more embodiments are described above by way of example only. Many variations are possible without departing from the scope of protection afforded by the appended claims.

1. A deck for a screening machine comprising:
a plurality of screen mats arranged to define a screen channel for screening a material;
a support framework comprising a plurality of transverse members, each transverse member comprising an edge retention channel within which an edge portion of at least one screen mat is received;
a rigid retention member which is received within the edge retention channel so as to clamp the edge portion in place, wherein the retention member is attached to the transverse member by a plurality of discrete attachments.

2. The deck of claim 1, wherein the attachments comprise a threaded attachment.

3. The deck of claim 2, wherein the threaded attachment comprises a nut and bolt, wherein the nut is attached to an underside of the transverse member.

4. The deck of claim 1, wherein the retention member is separated from a side wall of the edge retention channel so as to define a retention cavity in which the edge portion is clamped, wherein the retention cavity comprises a constriction at an upper end thereof.

5. The deck of claim 1, wherein the retention member is elongate with a longitudinal axis which extends along the length of the transverse member.

6. The deck of claim 5, wherein the retention member is tapered in cross section so as to narrow from an upper portion towards a base of the edge retention channel.

7. The deck of claim 1, wherein the retention member comprises a lip at an upper edge thereof, the lip providing a clamping surface which urges vertically downwards against a corresponding surface of the edge portion.

8. The deck of claim 1, wherein the transverse member comprises a box section on which the edge retention channel is formed.

9. The deck of claim 8, wherein the box section comprises a bolt sleeve through which one of the attachments passes.

10. The deck of claim 1, wherein the edge retention channel comprises a base and a pair of opposing sidewalls, wherein the sidewalls extend vertically and parallel to one another.

11. The deck of claim 10, wherein each of the opposing sidewalls comprises an inner surface which faces the retention member and an upper surface, wherein the edge portion is configured to abut the inner surface and the upper surface.

12. The deck of claim 1, further comprising a plurality of retention members, wherein the plurality of retention members comprises a central retention member and an end retention member.

13. The deck of claim 12, wherein the end retention member comprises a curved elongate member.

14. The deck of claim 1, wherein the retention member comprises a composite structure having a central member and an outer covering.

15. The deck of claim 14, wherein the central member comprises metal and the outer cover comprises polyurethane.

16. The deck of claim 1, wherein the edge portion is clamped in a non-deformed state.

17. A screen mat for use in the deck of claim 1, comprising a main panel comprising a plurality of apertures for screening a material and an edge portion extending along an edge of the main panel, the edge portion comprising a retention flange which is received within the edge retention channel.

18. The screen mat of claim 17, wherein the retention flange comprises a neck portion at an upper end thereof.

19. The screen mat of claim 18, wherein the retention flange extends perpendicularly downwards from the main panel with an internal angle of 90 degrees.

20. The screen mat of claim 18, wherein the surface of the retention flange which abuts the retention member is inclined to the vertical so as to match the opposing abutting surface of the retention member.
